(19) United States
(12) Patent Application Publication
(10) Pub. No.: US 2023/0100145 A1
(43) Pub. Date: Mar. 30, 2023

(54) SYSTEMS AND METHODS FOR TRANSFERRING, GRADING, AND/OR HARVESTING AQUATIC ANIMALS

(71) Applicant: Running Tide Technologies, Inc., Portland, ME (US)

(72) Inventors: Matthew Jordan ODLIN, Freeport, ME (US); Nathaniel MERRILL, Portland, ME (US); Eben SARGENT, Anchorage, AK (US); Matthew ANDERSON, South Portland, ME (US); Finnian DONOVAN, Cape Elizabeth, ME (US); David SOROKA, Portland, ME (US); Jason TURNURE, Portland, ME (US); Samuel WOOLF, Brunswick, ME (US); Patch KESSLER, San Francisco, CA (US)

(73) Assignee: Running Tide Technologies, Inc., Portland, ME (US)

(21) Appl. No.: 18/073,922

(22) Filed: Dec. 2, 2022

Related U.S. Application Data
(63) Continuation of application No. PCT/US2021/035705, filed on Jun. 3, 2021.
(60) Provisional application No. 63/034,016, filed on Jun. 3, 2020.

(51) Int. Cl. A01K 61/90; G06M 7/02

(52) U.S. Cl. CPC A01K 61/90; G06M 7/02

(57) ABSTRACT

Embodiments described herein relate generally to systems and methods for transferring, grading, and/or harvesting aquatic animals. In some embodiments, an apparatus can include a vessel configured to facilitate access to aquatic animals contained in an aquaculture system, a grading system disposed on the vessel and configured to receive a plurality of aquatic animals and sort the aquatic animals based on a characteristic, and a return system disposed on the vessel and configured to transfer at least a portion of the plurality of aquatic animals back to the aquaculture system.

### CROSS-REFERENCE TO RELATED APPLICATIONS

This application claims the benefit of U.S. Provisional Patent Application Ser. No. 63/034,016, entitled “Systems and Methods for Transferring, Grading, and/or Harvesting Aquatic Animals,” filed Jun. 3, 2020, the disclosure of which is incorporated by reference herein in its entirety.

### BACKGROUND

This disclosure relates to farming aquatic animals and more particularly, a systems and methods for transferring, grading, and/or harvesting aquatic animals cultivated in an aquaculture system.

Aquaculture is a sustainable and environmentally friendly approach to producing protein-rich sources of food in which aquatic species including fish, crustaceans, mollusks, aquatic plants, algae, and other organisms are cultivated. Conventional approaches for cultivating aquatic animals, for example, animals of the phylum Mollusca, including but not limited to oysters, clams, mussels, scallops, bivalves, abalone, etc., involve placing the mollusks on a bed located at the bottom of a body of water where the mollusks can grow naturally, similar to wild mollusks. The mollusks grown in this manner are typically harvested by dredging, a process that can be time consuming, labor intensive, and limited to shallow water environments.

Alternatively, mollusks can be grown using aquaculture systems including a series of enclosures (e.g., upwelling and/or downwelling systems, cages, racks, or bags) suspended in a body of water during the different stages of mollusk development. Upwelling and/or downwelling systems can protect the mollusks, facilitate controlling environmental conditions during development, and enable deployment of the aquaculture system in a deep-water environment where the quality of water is generally better compared to water near shore due to lower pollution and stronger water circulation. Once the mollusks grow to a certain size, the mollusks are typically transferred to a larger upwelling and/or downwelling system to facilitate further development and/or for harvesting, which can include grading, sorting, and/or the like. However, some known methods of transferring the mollusks between multiple enclosures and/or some known methods of harvesting the mollusks can be expensive and labor intensive.

Accordingly, a need exists for improved systems and methods for transferring, grading, and/or harvesting aquatic animals cultivated in aquaculture systems.

### SUMMARY

Embodiments described herein relate generally to systems and methods for transferring, grading, and/or harvesting aquatic animals. In some embodiments, an apparatus can include a vessel configured to facilitate access to aquatic animals contained in an aquaculture system, a grading system disposed on the vessel and configured to receive a plurality of aquatic animals and sort the aquatic animals based on a characteristic, and a return system disposed on the vessel and configured to transfer at least a portion of the plurality of aquatic animals back to the aquaculture system.

In some embodiments, a service vessel for grading or harvesting aquatic animals from an aquaculture system comprises a pair of hulls to allow the vessel to float over the aquaculture system. The service vessel has a transfer system configured to remove a plurality of aquatic animals from the aquaculture system, a grading system configured to receive the plurality of aquatic animals from the transfer system and sort the plurality of aquatic animals based on a characteristic, and a return system disposed on the vessel and configured to transfer at least a portion of the plurality of aquatic animals back to the aquaculture system.

In some embodiments, a method includes removing a plurality of aquatic animals from an aquaculture system, transferring the plurality of aquatic animals to a grading system disposed on a service vessel, sorting plurality of aquatic animals based on a characteristic of the aquatic animals, discarding a first portion of the plurality of aquatic animals that fall below a first predetermined size threshold, and returning a second portion of the plurality of aquatic animals that are above a second predetermined size threshold to the aquaculture system.

In some embodiments, a system can include a vessel configured to engage and interact with an aquaculture system to transfer aquatic animals therebetween. The vessel can include a vacuum system, a grading/sorting system, a set of tanks, and a return system. The vacuum system can be configured to transfer aquatic animals between the aquaculture system and the vessel. The grading/sorting system can grade, sort, count, and/or sample aquatic animals based on one or more predetermined characteristic(s) such as size, color, shape, weight, health, etc. The set of tanks can receive the aquatic animals from the grading/sorting system and at least temporarily store the aquatic animals. The return system can selectively return at least a portion of the aquatic animals such as those that do not satisfy the one or more predetermined characteristics. The vessel can also include a control system that be used to monitor, automate, and/or control on or more processes and/or systems.

### BRIEF DESCRIPTION OF THE DRAWINGS

It is to be understood that the drawings primarily are for illustrative purposes and are not intended to limit the scope of the subject matter described herein.

FIG. 1 is a schematic illustration of a vessel for grading and harvesting aquatic animals cultivated in an aquaculture system, according to an embodiment.

FIGS. 2 and 3 are a front perspective view and a rear perspective view, respectively, of a vessel for grading and harvesting aquatic animals and an aquaculture system in which the aquatic animals are cultivated, according to an embodiment.

FIGS. 4-6 are a front view, a rear perspective view, and a top view, respectively, of the vessel (shown without a rear cover) and a portion of the aquaculture system, shown in FIG. 2.

FIGS. 7-9 are a front view, a rear view, and a side perspective view of the vessel of FIG. 2 shown without the rear cover and without a front wheelhouse to illustrate a grading/sorting system, a return system, and a set of holding tanks thereof.

FIGS. 10-12 are a rear perspective view, a front view, and a top view, respectively, of at least a portion of the grading/sorting system of FIG. 7.

FIG. 13 is a side perspective view of a counter/scanner and conveyer included in the grading/sorting system of FIG. 7.

FIG. 14 is a flowchart schematically illustrating an example method of using a system for grading and harvesting aquatic animals cultivated in an aquaculture system, according to an embodiment.

### DETAILED DESCRIPTION

The present disclosure is directed to systems and methods for transferring, grading, and/or harvesting aquatic animals such as, for example, those cultivated in an aquaculture system. In some embodiments, a system can include a vessel configured to selectively engage and interact with an aquaculture system to transfer aquatic animals therebetween. The vessel includes a vacuum system configured to transfer the aquatic animals between the aquaculture system and the vessel, a grading/sorting system for grading, sorting, and/or sampling the aquatic animals based on one or more predetermined characteristic(s) such as size, weight, color, health, etc., a series of tanks for collecting and/or at least temporarily storing the selected aquatic animals, and a return system for selectively returning to the aquaculture system at least a portion of the aquatic animals such as, for example, aquatic animals that do not satisfy the one or more predetermined characteristic. The vessel can also include a control system that can be used to monitor, automate, and/or control one or more processes and/or systems used in transferring, grading, and/or harvesting operations. In some implementations, the control system can include and/or can be executed on a compute device or controller physically disposed on the vessel. In some implementations, the control system can include and/or can be executed on compute device or controller that is remote and/or otherwise not physically disposed on the vessel.

The vessels described herein can be any suitable floatable vessel, watercraft, boat, ship, raft, etc. that can be operated in or on a body of water to selectively engage and/or interact with one or more aquaculture systems that are disposed in that body of water. For example, the vessels described herein can be controlled (e.g., via human input or at least semi-autonomously) to place the vessels near, adjacent, and/or parallel to one or more pens of an aquaculture system allowing one or more systems of the vessel to transfer aquatic animals therebetween. In some embodiments, the vessel can be a multi-hulled watercraft including at least two hulls that can allow the vessel to travel over, float over, and/or otherwise straddle one or more pens of the aquaculture system, providing access thereto. For example, the vessel can be a catamaran, a pontoon boat, or any other suitable floating dual-hull vessel, craft, or vehicle. In some embodiments, the vessel can be a single hull watercraft configured to float near, next to, and/or adjacent to the aquaculture system providing access thereto. In some embodiments, the vessel can have one or more deck(s), tow and/or power crane(s), compressor(s), pump(s), tank(s) (e.g., holding tanks), refrigerated hold(s), electrical generator(s), grader(s), sorter(s), scanner(s), counter(s), hose(s) or other plumbing, compute device(s), communication device(s), and/or any other suitable equipment. In some embodiments, the vessel can be powered by diesel fuel, natural gas, solar energy, biofuel(s), batteries, or any other form of energy storage and conversion device. In other embodiments, the vessel can be manually operated by a human (e.g., by rowing, through the use of a paddlewheel, etc.).

As used in this specification and in the claims, the singular forms “a,” “an,” and “the” include plural referents unless the context clearly dictates otherwise. Thus, for example, the term “a member” is intended to mean a single member or a combination of members, “a material” is intended to mean one or more materials or a combination thereof, etc.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

As used herein, the phrase “and/or,” should be understood to mean “either or both” of the elements so conjoined (e.g., elements that are conjunctively present in some cases and disjunctively present in other cases). Multiple elements listed with “and/or” should be construed in the same fashion (e.g., “one or more” of the elements so conjoined). Other elements may optionally be present other than the elements specifically identified by the “and/or” clause, whether related or unrelated to those elements specifically identified. Thus, as a non-limiting example, a reference to “A and/or B”, when used in conjunction with open-ended language such as “including,” “comprising,” etc., can refer, in one implementation, to A only (optionally including elements other than B); in another implementation, to B only (optionally including elements other than A); and in yet another implementation, to both A and B (optionally including other elements).

As used herein, the term “or” should be understood to have the same meaning as “and/or” as defined above. For example, when separating items in a list, “or” or “and/or” shall be interpreted as being inclusive (e.g., the inclusion of at least one, but also including more than one) of a number or list of elements, and, optionally, additional unlisted items.

As used herein, the term “set” can refer to multiple features or a singular feature with multiple parts. For example, when referring to a set of walls, the set of walls can be considered as one wall with multiple portions, or the set of walls can be considered as multiple, distinct walls. Thus, a monolithically constructed item can include a set of walls. Such a set of walls may include multiple portions that are either continuous or discontinuous from each other. A set of walls can also be fabricated from multiple items that are produced separately and are later joined together (e.g., via a weld, an adhesive, or any suitable method).

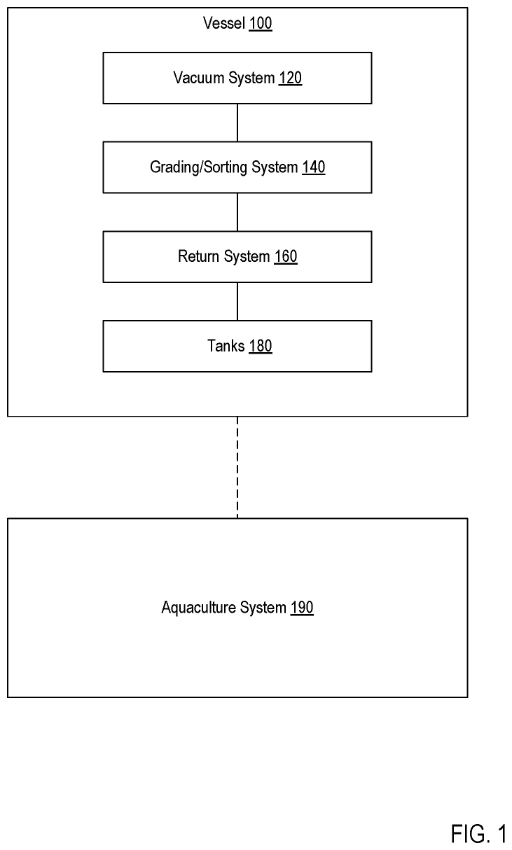

FIG. 1 is a schematic block diagram of a vessel 100 for transferring, grading, and/or harvesting aquatic animals according to an embodiment. For example, in some implementations, the vessel 100 can be configured to access, transfer, grade, and/or harvest aquatic animals cultivated in an aquaculture system 190. In some implementations, the aquaculture system 190 can be any suitable system configured to facilitate the development of aquatic animals such as animals from the phylum Mollusca (e.g., oysters, clams, mussels, scallops, bivalves, abalone, and/or the like). In some embodiments, the aquaculture system 190 can be similar to or substantially the same as any of the aquaculture systems described in U.S. Pat. No. 10,945,417, filed Jul. 24, 2019, entitled, “Systems and Methods for the Cultivation of Aquatic Animals,” (“the '417 Patent”), the disclosure of which is incorporated herein by reference in its entirety. In other embodiments, the vessel 100 can be used with aquaculture systems configured to cultivate any suitable aquatic species, animal, and/or plant.

The vessel 100 can include a vacuum system 120, a grading/sorting system 140, a return system 160, and a set of tanks 180. The vacuum system 120 can be configured to transfer aquatic animals, for example, animals of the phylum Mollusca, including but not limited to oysters, clams, mussels, scallops, bivalves, abalone, and/or the like between the vessel 100 and one or more enclosures of the aquaculture system 190. The grading/sorting system 140 can be coupled to the vacuum system 120 to grade, sort, and/or sample the aquatic animals based on one or more predetermined characteristics. The grading/sorting system 140 can also be coupled to the set of tanks 180 configured to contain, and/or store sorted aquatic animals. The return system 160 can be coupled to and/or can engage at least a portion of the grading/sorting system 140, the vacuum system 120, and/or the tanks 180. For example, in some implementations, the return system 160 can be configured to collect from the set of tanks 180 a portion of the aquatic animals disposed therein (such as those that do not have the predetermined characteristic(s) and/or that do not satisfy one or more predetermined criterion(ia)) and return them to the aquaculture system 190. In some embodiments, the grading/sorting system 140 can be directly coupled to the return system 160, which can be used to return some or all of the aquatic animals to the aquaculture system 190. The set of tanks 180 can also be coupled to and/or at least in communication with the vacuum system 120, the grading/sorting system 140, and/or the return system 160. In some embodiments, the set of tanks 180 can be a set of one or more holding tanks or the like configured to collect and/or at least temporarily hold the aquatic animals transferred to the vessel 100 from the aquaculture system 190.

As described above, in some embodiments, the vacuum system 120 can be configured to transfer aquatic animals between the vessel 100 and one or more enclosures or pens of the aquaculture system 190. The vacuum system 120 can include at least one vacuum pump, a vacuum line, and an engagement/support device such as an articulated spar, a boom, and/or the like. The vacuum pump can be used to generate a pressure differential. The vacuum pump can be any suitable pump including, but not limited to a rotary vane pump, a diaphragm pump, a piston pump, a scroll pump, a Wankel pump, a venturi pump, and/or the like. The vacuum pump can be substantially disposed inside a housing for protection from the surrounding environment and can be operably coupled to a power supply to receive electrical power operable to drive the pump(s).

The vacuum line can be coupled to the vacuum pump to route the vacuum and/or negative pressure generated by the vacuum pump to various components and/or locations. The vacuum line can be any suitable pipe or tubing configured to withstand a pressure differential generated by the vacuum pump. The vacuum line can be supported on or by the engagement/support device, which in turn, can facilitate engagement with and/or support of the vacuum line. For example, the engagement/support device can be an articulated spar or boom that can support the vacuum line and facilitate movement of the vacuum line relative to a desired portion of the aquaculture system 190. In some embodiments, such a spar or boom can allow the vacuum line to be at least partially disposed in the enclosures or pens of the aquaculture system 190 such that the negative pressure within the vacuum line draws aquatic animals from the aquaculture system 190 and into or onto the vessel 100. In some embodiments, the engagement/support device can include any number of components, mechanical linkages, couplers, joints, and/or the like including but not limited to one or more of a base, an end tip or effector, an one or more links connected by a kinematic, rotary, and/or motor-actuated joints, and/or the like. As such, the engagement/support device can be configured to provide various ranges of rotational and/or translational motion (with any number of degrees of freedom) allowing the vacuum line to be placed in any number of desirable positions. In some embodiments, the engagement/support device can be operated manually (e.g., via human input). In some embodiments, the engagement/support device can be electronically, mechanically, pneumatically, and/or hydraulically controlled. In some embodiments, the engagement/support device can be programmable, semi-autonomous, and/or fully autonomous.

The grading/sorting system 140 can be configured to receive, grade, sort, count, and/or sample aquatic animals. For example, in some implementations, the grading/sorting system 140 can be configured to receive aquatic animals and grade and/or sort the aquatic animals (e.g., mollusks) according to a binary grading system (e.g., a Pass/Fail system) in which the aquatic animals are evaluated based on a characteristic, criterion, and/or metric such as, for example, a predetermined weight (or weight threshold), a predetermined size (or size threshold), or a specific geometry (e.g., shape). The grading/sorting system 140 can be configured to sort and/or group the aquatic animals that fall above the evaluated characteristic or that match said characteristic (e.g., aquatic animals greater than a predetermined size, or aquatic animals that match a specific shape) into a Pass subset. Similarly, the grading/sorting system 140 can be configured to sort or group the aquatic animals that fall below the evaluated characteristic or do not match said characteristic (e.g., aquatic animals smaller or less than a predetermined size threshold, or aquatic animals that do not match a specific shape) into a Fail sub set.

The grading/sorting system 140 can be further configured to transfer at least a portion of the aquatic animals that fall above the evaluated characteristic or match said characteristic (e.g., aquatic animals sorted and/or grouped in the Pass subset) to the aquaculture system 190 and/or to the tanks 180. In some instances, the grading/sorting system 140 can be configured to transfer at least a portion the aquatic animals that do not satisfy the evaluated characteristic (e.g., aquatic animals sorted and/or grouped in the Fail subset) to the return system 160. In other instances, the grading/sorting system 140 can be configured to discard at least a portion the aquatic animals that do not satisfy the evaluated characteristic (e.g., aquatic animals sorted and/or grouped in the Fail subset) on the body of water in which the vessel 100 is being operated.

In some implementations, the grading/sorting system 140 can be configured to grade and/or sort the aquatic animals (e.g., mollusks) based on multiple specified or predetermined characteristic(s), criterion(ia), and/or the like. In other instances, the grading/sorting system 140 can be configured to obtain one or more subsets of aquatic animals selected randomly, or according to specific criteria. In some embodiments, the grading/sorting system 140 can include a hopper, a sorting device, a frame, an isolator element, a conveyor system, and one or more scanners. In some embodiments, the hopper can be coupled to the vacuum system 120 and configured to contain, store, aggregate, and/or otherwise transfer aquatic animals received from the vacuum system 120. In some embodiments, the hopper can be configured to reduce an amount of water transferred into the hopper as the aquatic animals (e.g., mollusks) are transferred to the hopper. The hopper can also be coupled to the sorting device and configured to transfer the aquatic animals contained in the hopper to the sorting device for sorting, grading, and/or sampling subsets of aquatic animals according to one or more predetermined characteristic, such as size, shape, and/or geometry. In other embodiments, the grading/sorting system 140 need not include a hopper. For example, the vacuum system 120 can be configured to deliver the aquatic animals directly to the sorting device without the use of a hopper.

In some embodiments, the hopper can include a vibrating feed, a pneumatic feed, and/or the like. In some embodiments, the hopper can include a drum, an elevator, a storage tank, one or more inlets and/or outlets, and/or the like. The hopper can be made various materials including, but not limited to, stainless steel, aluminum, nickel-chromium alloy (Ni—Cr), and/or any other suitable metal or metal alloy material. The hopper can be coated with various coatings including, but not limited to polyamide, epoxy, polyurethane, neoprene, Rilsan, Nuflon, microbead coatings, and/or the like. In some embodiments, the hopper can be operably coupled to the vacuum system 120 and/or the return system 160 operable to provide a pressure differential within the hopper.

In some implementations, transferring aquatic animals to the hopper can include transferring a flow of volume of water in addition to the aquatic animals. In such implementations, the shape and/or configuration of the hopper can be such that the aquatic animals pass through the hopper to the sorting device while excess water is extracted and/or released from the hopper. For example, the hopper can include one or more ports or the like that can be coupled to the vacuum system 120 and/or the return system 160, which in turn, can be used to create a pressure differential and/or a preferential flow of water through and/or around the hopper that allows the excess water to exit the hopper via the port.

As described above, the sorting device can be coupled to the hopper to receive, sort, grade, and/or sample aquatic animals according to predetermined characteristics. The sorting device, for example, can be a circle-throw vibrating sorter, a high frequency vibrating sorter, a gyratory sorter, a trommel screen sorter, a tumbler screener, and/or the like. In some embodiments, the sorting device can include, for example, one or more vibratory motor(s), and a set of screens, each of which having a different mesh, pore, and/or opening size and/or shape, configured to separate the aquatic animals (e.g., mollusks) into different groups according to the mollusks size, shape, weight, and/or the like. In some embodiments, the sorting device can include an oscillating resonant mechanism powered by a linear vibrating drive configured to control the vibration amplitude, frequency, etc., and/or to hold the mechanism in resonance (i.e., at a frequency close to its natural frequency). In some embodiments, the sorting device can be a rotating tumbler including a drum or the like with multiple hole sizes, mesh sizes, pore sizes, etc., and a drive motor (e.g., an adjustable speed motor) configured to separate and/or remove aquatic animals having a size smaller or less than the hole size(s) from the aquatic animals having a size larger or greater than the hole size(s). In some embodiments, the sorting device can include any other suitable separator, sorter, grader, etc.

In some embodiments, the sorting device can include multiple separators, screens, sorters, etc. allowing the sorting device to separate and/or sort the aquatic animals into any number of groups (e.g., according to a predetermined size or size threshold, a predetermined weight or weight threshold, a specific shape, etc.). In some embodiments, the sorting device can be made of stainless steel, aluminum, Ni—Cr, and/or any other suitable metal or metal alloy material. In some embodiments, the sorting device can be powered manually, powered by electricity and/or an electric motor, and/or powered by an engine (e.g., an engine configured to combust and/or consume diesel fuel, gasoline, natural gas, biofuel, and/or the like. In some embodiments, the sorting device can be coupled to a control system (not shown) configured to control and/or communicate with one or more portions of the vessel 100. In some embodiments, such a control system can be configured to monitor and/or control one or more aspects, parameters, functions, and/or operations of the sorting device by executing and/or implementing user provided input or instructions, an automated or semi-automated control algorithm, an artificial intelligence, machine learning, and/or adaptive algorithm or system, and/or the like.

The sorting device can include, for example, an outlet or the like that can allow sorted aquatic animals to exit the sorting device. In some embodiments, the outlet can be and/or can include a manifold or the like that can direct the sorted aquatic animals to additional components of the grading/sorting system 140 such as, for example, the conveyer system. More particularly, the outlet and/or manifold can include multiple channels, tubes, chutes, tracks, ports, and/or structures, each of which receiving a sorted subset of the aquatic animals (e.g., based on size, shape, weight, etc.). In some embodiments, for example, the sorting device can be configured to sort aquatic animals according to a binary grading system (e.g., Pass/Fail system) with respect to an evaluated characteristic, criterion, and/or metric such as predetermined weight (or weight threshold), a predetermined size (or size threshold), or a specific geometry (e.g., shape). In such embodiments, the sorting device can include an outlet or an outlet manifold that can provide a first structure configured to direct the aquatic animals that meet the evaluated characteristic (e.g., aquatic animals that fall above a predetermined size or match a specific shape) to a first (Pass) conveyer, and a second structure configured to direct the aquatic animals that do not meet the evaluated characteristic (e.g., aquatic animals that fall below a predetermined size threshold or do not match a specific shape) to a second (Fail) conveyer. The first (Pass) conveyer can be configured to transfer the aquatic animals to the aquaculture 190 and/or to the set of tanks 180. In some instances, the second (Fail) conveyer can be configured to transfer to at least a portion of the aquatic animals to the return system 160. In other instances, the second (Fail) conveyer can be configured to discard at least a portion of the aquatic animals on the body of water on which the vessel 100 is being operated.

In some embodiments, the sorting device can be configured to sort aquatic animals into two, three, four, five, six, seven, eight, nine, ten or more sorted subsets of aquatic animals (e.g., mollusks) based on a desired and/or predetermined characteristic and/or criteria. In some such embodiments, the sorting device can include outlet(s) or an outlet manifold that can provide a corresponding number of structures configured to provide the separated or sorted aquatic animals to different conveyers of the conveyer system based on the desired and/or predetermined characteristic and/or criteria.

In some embodiments, the sorting device can be coupled to a frame or support structure that can include one or more rigid, semi-rigid, and/or flexible structure(s) configured to provide mechanical support to the sorting device and/or the hopper. The frame can have dimensions sufficient to at least partially fit and/or support the hopper and sorting device. In some embodiments, at least a portion of the frame and/or support structure can be configured to dampen the vibrations generated during operation of the sorting device. For example, the frame can include a set of coils or springs to prevent the propagation of vibrations produced during operation. In some embodiments, the frame can be anchored or coupled to an isolator element configured to suppress the propagation of vibrations from the sorting device to other components of the grading/sorting system 140 and/or vessel 100. The isolator element can be a thick mat disposed underneath the frame to dampen the vibrations. The isolator element can be made of various materials that exhibit a natural vibration frequency different (e.g., above or below) the vibration frequency of the sorting device. The isolator element can be made of various materials including, for example, concrete, felt, rubber, cork, highly viscous fluid(s), and/or the like. In some embodiments, the isolator element can include one or more metal coils, pneumatic cylinders, hydraulic cylinders, and/or the like.

For example, the isolator element can include a set of gas struts (e.g., one or more gas struts) configured to reduce the propagation of the vibrations generated by the sorting device. The gas struts can be any size and/or suitable size, shape, and/or form. The gas struts can include various types of struts such as a fixed height cylinder, a spindle, a cable cylinder, a staged cylinder, a non-rotating cylinder, and/or the like and/or combinations thereof. The struts can include various features such as, for example, telescoping mechanisms for extending stroke, adjustable push-in force knobs or wires, degressive response mechanisms, and/or the like. The struts can include one or more tabs disposed along the length of the strut, which can function as mounting points to couple the struts to the isolation element. In some embodiments, a number of struts can be formed from a single component to simplify assembly.

The conveyor system can be coupled to the sorting device to transport and/or distribute the sorted aquatic animals. The conveyor system can be and/or can include one or more belt conveyors, chain conveyors, pneumatic conveyors, flexible conveyors, line shaft roller conveyor, screw or auger conveyors, and/or the like. In some embodiments, the conveyor system can be coupled to the sorting device to transport the sorted aquatic animals away from the sorting device. For example, each conveyer can be coupled to and/or aligned with a different outlet or different structure of an outlet manifold of the sorting device. In this manner, each conveyer can receive a sorted subset of the aquatic animals based on the predetermined characteristic and/or criteria (e.g., size, shape, weight, etc.). The conveyors are configured to convey the corresponding sorted subset of aquatic animals to either the set of tanks 180, to the return system 160, or to the body of water, facilitating collection of the aquatic animals, the return of the aquatic animals that do not meet the predetermined characteristic to the aquaculture system 190, or alternatively the discard of the aquatic animals that do not meet the predetermined characteristic on the body of water in which the vessel 100 is being operated.

In some embodiments, the conveyors are configured to convey the corresponding sorted subset of aquatic animals to or past one or more scanners configured to scan and/or count the number of aquatic animals sorted prior to conveying the aquatic animals to the set of tanks 180 and/or the return system 160. The scanners can be any suitable device, system, and/or mechanism configured to count the number of aquatic animals graded, sorted, and/or sampled. In some embodiments, the scanners can be coupled to the conveyor system and/or each conveyor included in the conveyer system. In some embodiments, the scanners can be coupled to each tank of the set of tanks 180. In some embodiments, scanners can be, for example, optical counter scanners such as, for example, light blocking counters, light scattering counters, direct imaging counters, and/or the like. In some embodiments, the optical counter scanner can include, for example, at least one high-speed camera configured to capture or record images from one or more viewing angles, and an image acquisition and image analysis unit configured to execute any suitable analysis software to provide high-speed counting with high accuracy. In some embodiments, the conveyor system can include one or more spreaders (e.g., a spreader for each conveyer) configured to place the aquatic animals in a desired configuration. For example, in some embodiments, the spreaders can organize and/or spread the aquatic animals (e.g., consecutively in one or more lines) to facilitate counting with the optical counter scanners (e.g., light blocking optical counter scanners). While the scanners are described above as being coupled to the conveyer system and/or the set of tanks 180, in some embodiments, the scanners can be coupled to and/or included in the sorting device to count the total number of aquatic animals sorted.

The return system 160 can be configured, for example, to collect the aquatic animals that do not meet the predetermined characteristic and/or do not satisfy the predetermined criteria, and to transfer and/or return them to the aquaculture system 190. For example, in some embodiments, the return system 160 can be coupled to and/or at least partially disposed in the set of tanks 180 to transfer at least some of the aquatic animals contained in the tanks 180 to the aquaculture system 190. In some embodiments, the return system 160 can be coupled to the conveyor system to directly transport at least a portion of the aquatic animals sorted in the sorting device to the aquaculture system 190. The return system 160 can include at least one compressor(s) or other pumping device(s), a series of high-pressure lines or pipes, one or more ejector-jet pump (e.g., an aspirator or venturi pump), and a set of flexible hoses or hollow tubing. The compressor(s) can be configured such that fluid, gas, and/or air from an external source or from the atmosphere can be pressurized and flowed through the high-pressure lines coupled to the compressor. The high-pressure lines can also be coupled to one or more venturi pumps, wherein the flow of pressurized fluid results in a negative pressure differential (e.g., vacuum and/or suction force) within the venturi pump. The venturi pumps, in turn, can be coupled to a set of flexible hoses or hollow tubing configured to communicate the negative pressure differential (e.g., the vacuum and/or suction force) to draw aquatic animals from the tanks 180 and into the return system 160, which are then returned to the aquaculture system 190. In other implementations, the return system 160 can be used to transport aquatic animals to one or more other storage members, holders, conveyers, etc. of a harvesting system or the like (e.g., not necessarily included in the vessel 100). For example, the return system 160 can be used to offload the sorted and collected aquatic animals at a processing facility or the like.

The compressors can include one or more of a low-pressure compressor, a medium-pressure compressor, a high-pressure compressor, and/or any suitable combination thereof. The compressor(s) can be positive displacement compressors, dynamic displacement compressors, single stage reciprocating compressors, two-stage reciprocal compressors, screw-type compressors, rotary vane pumps, scroll compressor, turbo compressors, centrifugal compressors, and/or the like. The compressors can be configured to be cooled by air, water, or an oil working fluid. In some embodiments, the compressor(s) can be configured to provide a flow of compressed or pressurized fluid at any suitable pressure such as, for example, a pressure sufficient to activate the pumps (e.g., venturi pumps) and/or otherwise result in a desired amount of vacuum produced by the pumps.

As described above, the high-pressure lines can be coupled to the compressor(s) to flow the compressed fluid (e.g., air) to the desired components. In some embodiments, the high-pressure lines can be made of metals or metal alloys such as cast iron, copper, carbon steel, galvanized steel, stainless steel, aluminum, and/or any suitable material. In some embodiments, the high-pressure lines can be made of polymers and/or plastics such as polyvinylchloride (PVC), polyethylene(s), polypropylene(s), polyurethane(s), nylon(s), and/or the like or copolymers thereof. The high-pressure lines can include various accessories such as valves, fittings, line filters, check valves, safety heads, rupture discs and the like configured to facilitate the flow of compressed fluid to one or more intended locations. The high-pressure lines can be coupled to one or more venturi pumps or aspirators configured to generate a pressure differential (e.g., a vacuum). The venturi pumps can be configured to generate a pressure differential by the venturi effect. To that end, the venturi pumps can be coupled to flexible hoses or hollow tubing of the return system 160. For example, a first flexible hose and/or hollow tubing can extend from an inlet side of one of the venturi pumps and into a corresponding tank 180 from the set of tanks 180, and a second flexible hose and/or hollow tubing can extend from an outlet side of the venturi pump and to, for example, an outlet or outflow of the return system 160. As such, in some instances, the pressure differential generated by the venturi pumps can be used to transfer some of the aquatic animals (e.g., those that are too small or that otherwise do not meet or satisfy a predetermined criterion) to the enclosures or pens of the aquaculture system 190. The flexible hoses can be any suitable flexible hose or hollow tube that possess a mechanical strength sufficient to not collapse in response to the vacuum or negative pressure created therein. For example, the flexible hoses can be made of various materials such as thermoplastic elastomers (TPEs), poly vinyl chloride (PVC), rubber, norprene, neoprene, polyethylene, polypropylene, silicon, nylon, and/or the like or copolymers thereof.

The set of tanks 180 can be coupled to and/or aligned with the conveyor system and configured to receive, contain, and/or store at least some of the aquatic animals sorted by the grading/sorting system 140. The set of tanks 180 can be any suitable shape and/or size. In some embodiments, the tanks 180 can be disposed in and/or formed by a hull of the vessel 100 or portion thereof. For example, in some embodiments, the vessel 100 can be a catamaran or a pontoon boat with two hulls or pontoons positioned on opposite sides of the vessel 100. In such embodiments, one or both of the hulls or pontoons can include and/or can form one or more of the tanks 180.

The set of tanks 180 can be dimensioned to contain a minimum amount of water and/or liquid solution to facilitate preserving the aquatic animals disposed therein. The set of tanks 180 can include a water recirculation system (not shown) with one or more bio-filters, sand filters, and/or ultra-violet filters to purify, clean, and/or sterilize the water and preserve the aquatic animals. The set of tanks 180 can also include a valve, inlet, or port (not shown) configured to allow a flow of liquid into or out of the tanks 180 (e.g., to at least partially fill one or more tanks 180 with water, collect samples of water for quality control purposes, and/or the like).

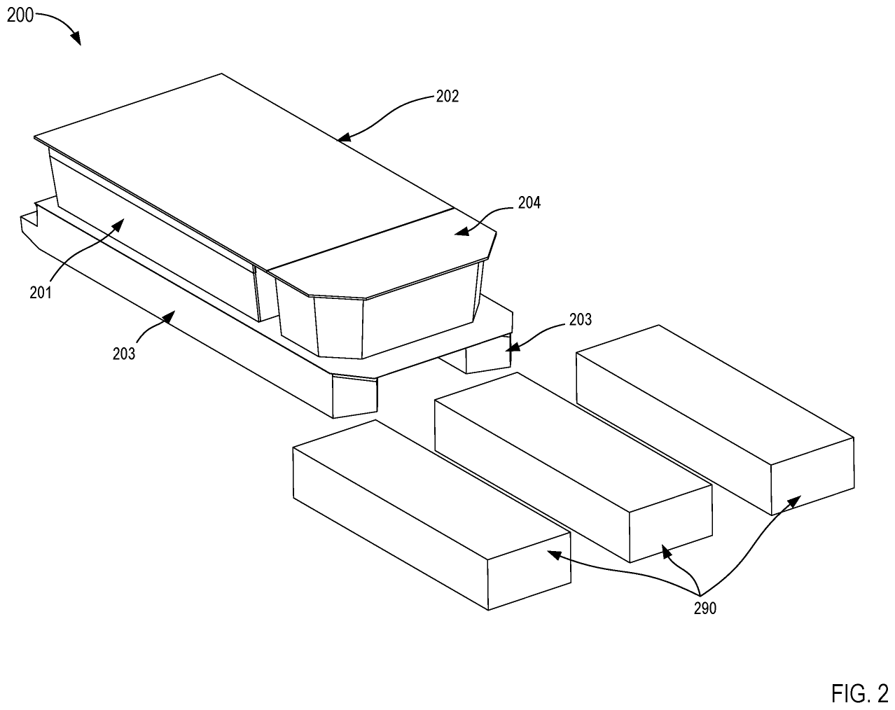

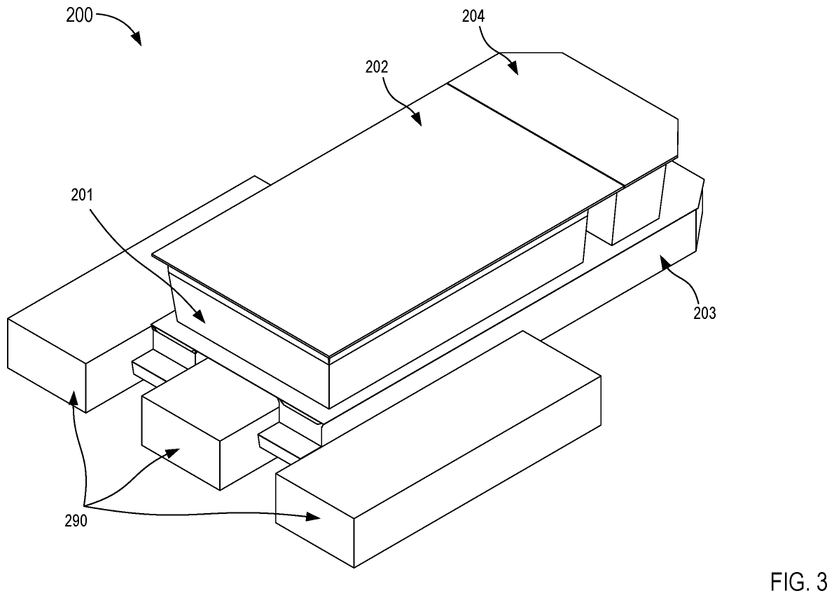

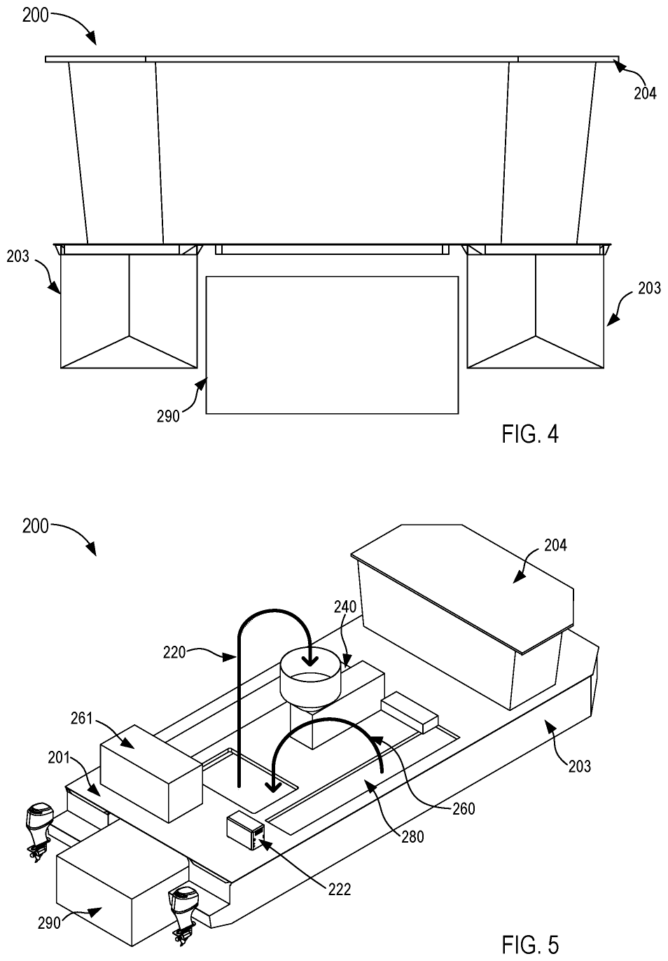

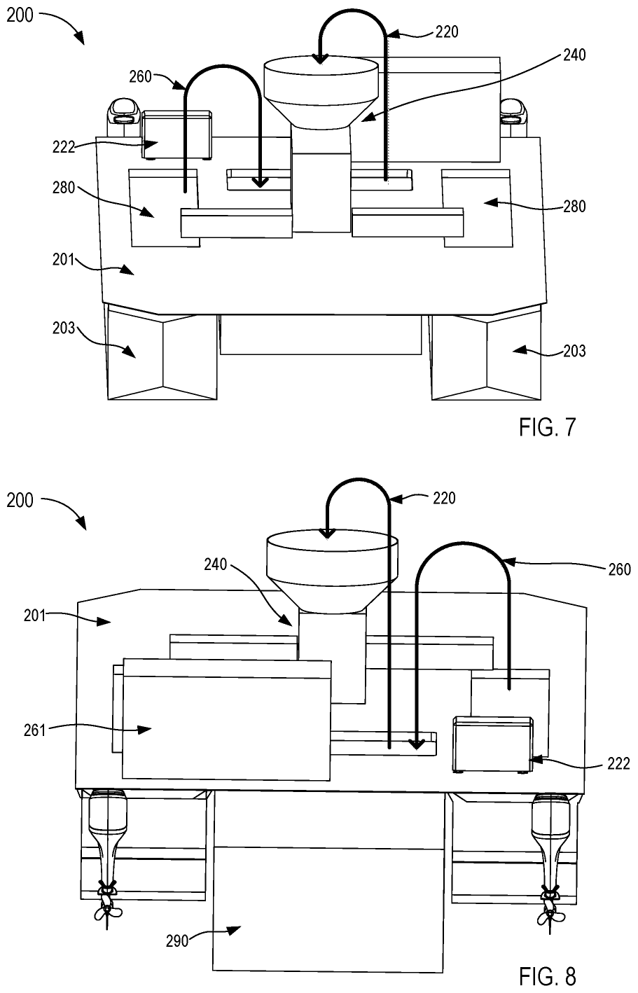

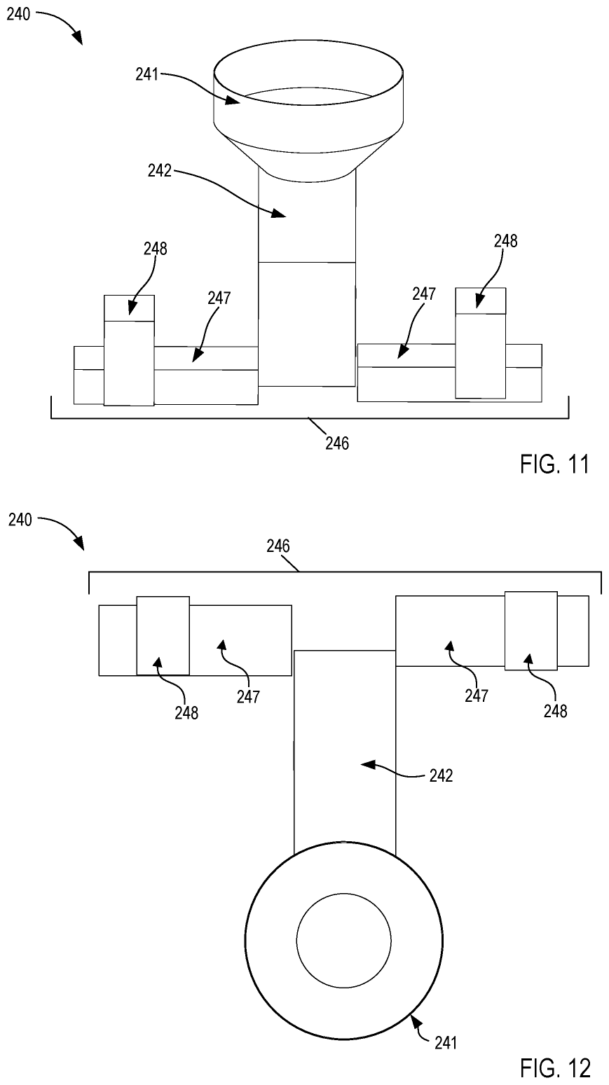

FIGS. 2-13 show a vessel 200 for transferring, grading, and/or harvesting aquatic animals according to an embodiment. For example, in some implementations, the vessel 200 can be configured to access, transfer, grade, and/or harvest aquatic animals cultivated in an aquaculture system 290. In some implementations, the aquaculture system 290 can be any suitable system configured to facilitate the development of aquatic animals such as animals from the phylum Mollusca (e.g., oysters, clams, mussels, scallops, bivalves, abalone, and/or the like). In some embodiments, the aquaculture system 290 can be similar to or substantially the same as any of the aquaculture systems described in the '417 Patent. In other embodiments, the vessel 200 can be used with aquaculture systems configured to cultivate any suitable aquatic species, animal, and/or plant.

The vessel 200 can be any suitable floatable vessel, watercraft, boat, ship, raft, etc. that can be operated in or on a body of water to selectively engage and/or interact with one or more aquaculture systems that are disposed in that body of water. For example, the vessel 200 can be controlled (e.g., via human input or at least semi-autonomously) to place the vessel 200 near, adjacent, and/or parallel to one or more pens of the aquaculture system 290 allowing one or more systems of the vessel 200 to transfer aquatic animals therebetween. As shown in FIGS. 2-4, the vessel 200 includes a deck 201, a rear cover 202, a set of hulls 203, and a wheelhouse 204. The deck 201 can be any suitable shape, size, and/or configuration. In some embodiments, the vessel 200 can be a multi-hulled watercraft including at least two hulls 203 that can allow the vessel 200 to travel over, float over, and/or otherwise straddle one or more pens of the aquaculture system 290, providing access thereto. For example, the vessel 200 can be a catamaran, pontoon boat, or any other suitable floating vessel, craft, or vehicle having a pair of hulls 203 on opposite sides of the vessel 200. The deck 201 can be disposed above and extend between the hulls 203. The deck 201 can provide one or more platforms to which equipment can be mounted and/or on which operator(s) of the vessel 200 can stand, walk, and/or otherwise operate the vessel 200. The rear cover 202 can extend over and/or can cover the deck 201 to protect the various equipment, operators, and/or aquatic animals on board the vessel 200 from exposure to winds, rain, heat, and/or excessive ultraviolet radiation. The wheelhouse 203 can be positioned in front (fore) of the deck 201. The wheelhouse 203 can include any suitable system, device, mechanism, computer and/or electronic system, communication system, and/or the like associated with operating, driving, and/or controlling at least a portion of the vessel 200. For example, an operator (e.g., a captain, a driver, etc.) can operate one or more systems or devices in the wheelhouse 203 to drive the vessel 200 over one or more pens of the aquaculture system 290. As such, the one or more pens of the aquaculture system 290 are positioned between the hulls 203 and at least partially below the deck 201 (see e.g., FIGS. 2-4).

As shown in FIGS. 5-9, the vessel 200 can include a vacuum system 220 (designated by an arrow in FIGS. 5-9), a grading/sorting system 240, a return system 260 (designated by an arrow in FIGS. 5-9), and a set of tanks 280. The vacuum system 220 can be configured to transfer aquatic animals (e.g., mollusks) between the vessel 200 and one or more enclosures of the aquaculture system 290. The vacuum system 220 can be coupled to the grading/sorting system 240 to grade, sort, and/or sample the aquatic animals based on one or more predetermined characteristics. The grading/sorting system 240 can also be coupled to the set of tanks 280 configured to contain, and/or store sorted aquatic animals. The return system 260 can be coupled to and/or can engage at least a portion of the grading/sorting system 240, the vacuum system 220, and/or the tanks 280. For example, in some implementations, the return system 260 can be configured to collect from the set of tanks 280 a portion of the aquatic animals disposed therein (such as those that do not have the predetermined characteristic(s) and/or that do not satisfy one or more predetermined criterion(ia)) and return them to the aquaculture system 290. In some embodiments, the grading/sorting system 240 can be directly coupled to the return system 260, which can be used to return some or all of the aquatic animals to the aquaculture system 290. The set of tanks 280 can also be coupled to and/or at least in communication with the vacuum system 220, the grading/sorting system 240, and/or the return system 260. In some embodiments, the set of tanks 280 can be a set of one or more holding tanks or the like configured to collect and/or at least temporarily hold the aquatic animals transferred to the vessel 200 from the aquaculture system 290. The vessel 200 can also include a power system and a control system (not shown) to supply power and monitor/control the different components on board the vessel 200. In some embodiments, one or more portions of the vessel 200 can be similar to or substantially the same as one or more corresponding portions of the vessel 100 described above with reference to FIG. 1. Accordingly, such portions may not be described in further detail herein.

As described above, in some embodiments, the vacuum system 220 can be configured to transfer aquatic animals between the vessel 200 and one or more enclosures or pens of the aquaculture system 290. In some embodiments, the vacuum system 220 can be similar to or substantially the same as the vacuum system 120 described above with reference to FIG. 1. As shown in FIGS. 5-9, the vacuum system 220 can include at least one vacuum pump 222 used to generate a pressure differential. The vacuum pump 222 can be any suitable pump including, but not limited to a rotary vane pump, a diaphragm pump, a piston pump, a scroll pump, a Wankel pump, a venturi pump, and/or the like. The vacuum pump 222 can be substantially disposed inside a housing (not shown) for protection from the surrounding environment and can be operably coupled to a power supply (not shown) to receive electrical power operable to drive the pump(s).

In some embodiments the vacuum system 220 can include a vacuum line or multiple vacuum lines (not shown) coupled to the vacuum pump 222 to route the vacuum and/or negative pressure generated by the vacuum pump 222 to various components and/or locations. The vacuum line can be any suitable pipe or tubing configured to withstand the pressure differential generated by the vacuum pump 222. The vacuum line can include various accessories including, but not limited to couplings, tees, elbows, adapters, valves, ports, and/or the like. In some embodiments, the vacuum line can be supported on or by an engagement/support device (not shown), which in turn, can facilitate engagement with and/or support of the vacuum line. For example, the engagement/support device can be an articulated spar or boom that can support the vacuum line and facilitate movement of the vacuum line relative to a desired portion of the aquaculture system 290. In some embodiments, such a spar or boom can allow the vacuum line to be at least partially disposed in the enclosures or pens of the aquaculture system 290 such that the negative pressure within the vacuum line draws aquatic animals from the aquaculture system 290 and into or onto the vessel 200. In some embodiments, the engagement/support device can include any number of components, mechanical linkages, couplers, joints, and/or the like including but not limited to one or more of a base, an end tip or effector, one or more links connected by a kinematic, rotary, and/or motor-actuated joint(s), and/or the like. As such, the engagement/support device can be configured to provide various ranges of rotational and/or translational motion (with any number of independent motions or degrees of freedom) allowing the vacuum line to be placed in any number of desirable positions. In some embodiments, the engagement/support device can be operated manually (e.g., via human input). In some embodiments, the engagement/support device can be electronically, mechanically, pneumatically, and/or hydraulically controlled. In some embodiments, the engagement/support device can be programmable, semi-autonomous, and/or fully autonomous.

The grading/sorting system 240 can be any suitable system or combination of systems configured to grade, sort, count, and/or sample aquatic animals. In some embodiments, the grading/sorting system 240 can be similar to or substantially the same as the grading/sorting system 140 described above with reference to FIG. 1. For example, in some instances, the grading/sorting system 240 can be configured to receive aquatic animals and grade and/or sort the aquatic animals (e.g., mollusks) according to a binary grading system (e.g., a Pass/Fail system) in which the aquatic animals are evaluated based on a characteristic, criterion, and/or metric such as, for example, a predetermined weight (or weight threshold), a predetermined size (or size threshold), or a specific geometry (e.g., shape). The grading/sorting system 240 can be configured to sort and/or group the aquatic animals that fall above the evaluated characteristic or that match said characteristic (e.g., aquatic animals greater than a predetermined size, or aquatic animals that match a specific shape) into a Pass subset. Similarly, the grading/sorting system 240 can be configured to sort or group the aquatic animals that fall below the evaluated characteristic or do not match said characteristic (e.g., aquatic animals smaller or less than a predetermined size threshold, or aquatic animals that do not match a specific shape) into a Fail subset.

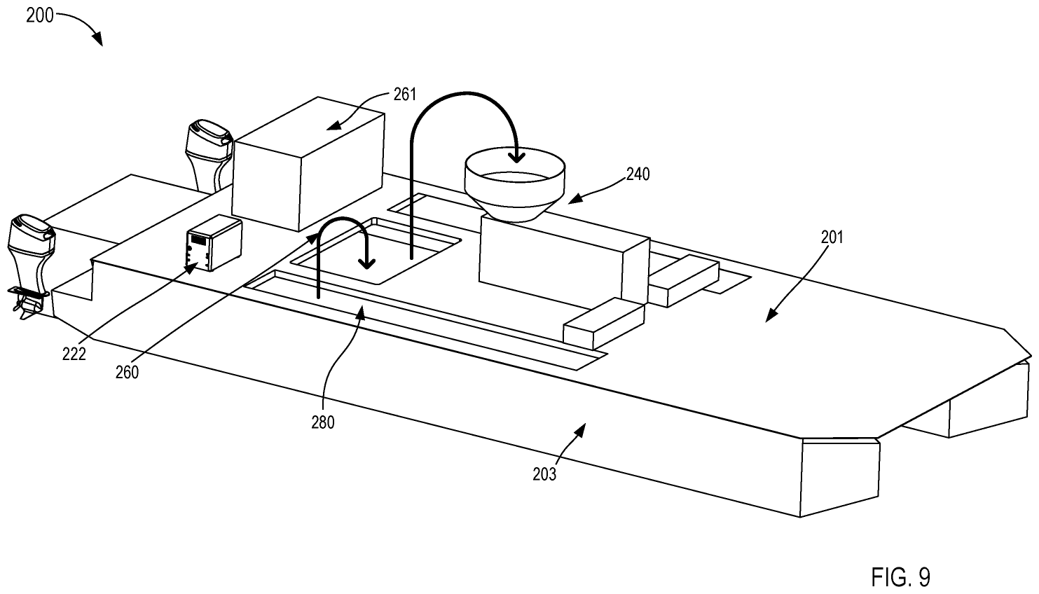

The grading/sorting system 240 can be further configured to transfer at least a portion of the aquatic animals that fall above the evaluated characteristic or match said characteristic (e.g., aquatic animals sorted and/or grouped in the Pass subset) to the aquaculture system 290 and/or to the tanks 280. In some instances, the grading/sorting system 240 can be configured to transfer at least a portion the aquatic animals that do not satisfy the evaluated characteristic (e.g., aquatic animals sorted and/or grouped in the Fail subset) to the return system 260. In other instances, the grading/sorting system 240 can be configured to discard at least a portion the aquatic animals that do not satisfy the evaluated characteristic (e.g., aquatic animals sorted and/or grouped in the Fail subset) on the body of water in which the vessel 200 is being operated In other instances, the grading/sorting system 240 can be configured to obtain one or more subsets of aquatic animals selected randomly, or according to specific criteria. As shown in FIGS. 9-13, the grading/sorting system 240 can include at least a hopper 241, a sorting device 242, a conveyor system 246, and one or more counters/scanners 248.

The hopper 241 of the grading/sorting system 240 can be made from or of various materials including, but not limited to, stainless steel, aluminum, Ni—Cr, and/or any other suitable metal or metal alloy. The hopper 241 can be coated with various coatings including, but not limited to polyamide, epoxy, polyurethane, neoprene, Rilsan, Nuflon, microbead, and/or the like to protect the aquatic animals from potential contamination. In other embodiments, the hopper 241 can be made from or of any suitable polymer such as any of those described herein. The hopper 241 can be coupled to the vacuum system 220 and configured contain, store, aggregate, and/or otherwise transfer aquatic animals received from the vacuum system 220. The hopper 241 can also be coupled to the sorting device 242 and configured to transfer the aquatic animals contained in the hopper 241 to the sorting device 242 for sorting, grading, and/or sampling subsets of aquatic animals according to one or more predetermined characteristic, such as size, shape, and/or geometry. In some embodiments, the hopper 241 can include a vibrating feed, a pneumatic feed, a drum, an elevator, a storage tank, one or more inlets and/or outlets, and/or the like, as described above with reference to the grading/sorting system 140 shown in FIG. 1. In some embodiments, the hopper 241 can be operably coupled to the vacuum system 220 and/or the return system 260 operable to provide a pressure differential within the hopper 241.

In some embodiments, the hopper 241 can be configured to reduce an amount of water transferred into the hopper 241 as the aquatic animals (e.g., mollusks) are transferred to the hopper 241. For example, the shape and/or configuration of the hopper 241 can be such that the aquatic animals pass through the hopper 241 to the sorting device 242 while excess water is extracted and/or released from the hopper 241. For example, the hopper 241 can include one or more ports or the like that can be coupled to the vacuum system 220 and/or the return system 260, which in turn, can be used to create a pressure differential and/or a preferential flow of water through and/or around the hopper 241 that allows the excess water to exit the hopper 241 via the port.

As described above, the sorting device 242 can be coupled to the hopper 241 to receive, sort, grade, and/or sample aquatic animals according to predetermined characteristics. For example, in some instances, the sorting device 242 can be configured to separate and/or sort the aquatic animals into one or more subsets of aquatic animals either randomly or according to a predetermined characteristic such as having a predetermined size (or size threshold), a predetermined weight (or weight threshold), or a specific geometry and/or shape. In some instances, the sorting device 242 can be configured to separate only aquatic animals that do not meet the specific characteristic such as being less than the predetermined size or being greater than the predetermined size. In some implementations, the sorting device 242 can be configured to grade and sort all the aquatic animals into different subgroups based on specific characteristics such as shape, weight, or relative size.

The sorting device 242, for example, can be any suitable sorting device such as those described above with reference to grading/sorting system 140 above. In some embodiments, for example, the sorting device 242 can include a vibratory motor(s), and a set of screens, each of which having a different mesh, pore, and/or opening size and/or shape, configured to separate the aquatic animals (e.g., mollusks) into one or more different groups according to the mollusks size, shape, weight, and/or the like. In some embodiments, the sorting device 242 can include multiple separators, screens, sorters, etc. allowing the sorting device 242 to separate and/or sort the aquatic animals into any number of separated groups or subsets based on desired characteristics and/or one or more predetermined criterion (e.g., a binary grading system).

In some implementations, the vibratory motor(s) can include an electric motor configured to rotate an unbalanced mass, thereby producing vibration. Moreover, the characteristics of the vibratory motor(s) (e.g., amount of mass, amount of unbalance, rotational velocity, torque, etc.) can be selected to provide a desired amount of vibration, vibration amplitude, vibration frequency, etc., and/or to hold at least a portion of the sorting device 242 in resonance (i.e., at a frequency close to its natural frequency). In some embodiments, the sorting device 242 can be coupled to a control system (not shown) configured to control and/or communicate with one or more portions of the vessel 200. In some embodiments, such a control system can be configured to monitor and/or control one or more aspects, parameters, functions, and/or operations of the sorting device 242 by executing and/or implementing user provided input or instructions, an automated or semi-automated control algorithm, an artificial intelligence, machine learning, and/or adaptive algorithm or system, and/or the like.

In some embodiments, the sorting device 242 can be coupled to a frame, which in turn, can be coupled to and/or includes an isolator element(s) configured to dampen the vibrations generated during operation of the sorting device 242. The frame can be and/or can include one or more rigid, semi-rigid, and/or flexible structure(s) configured to provide mechanical support to the sorting device 242 and/or the hopper 241. In some embodiments, the frame can have dimensions sufficient to at least partially fit and/or support the hopper 241 and sorting device. In some embodiments, at least a portion of the frame and/or support structure can be configured to dampen the vibrations generated during operation of the sorting device 242. For example, the frame can include a set of coils or springs to prevent the propagation of vibrations produced during operation of the sorting device 242. In addition, the frame can be coupled and/or anchored to an isolator element(s) to further suppress the propagation of vibrations from the sorting device 242 to other components of the grading/sorting system 240 and/or vessel 200.

In some embodiments, the isolator element(s) can be and/or can include, for example, a thick mat disposed underneath the frame to dampen the vibrations. The isolator element can be made of various materials that exhibit a natural vibration frequency different (e.g., above or below) the vibration frequency of the sorting device. For example, the isolator element can be made of various materials including concrete, felt, rubber, cork, highly viscous fluid(s), and/or any other suitable vibration absorbing material or combinations thereof.

In some embodiments, the frame and/or the isolator element can include and/or can be coupled to one or more metal coils, dampeners, pneumatic cylinders, hydraulic cylinders, and/or the like. For example, in some embodiments the isolator element can include a set of gas struts (e.g., one or more gas struts) configured to reduce the propagation of the vibrations generated by the sorting device 242. In some embodiments, the isolator element can include and/or can be coupled to, for example, four gas struts. The gas struts can be any suitable size, shape, and/or form. The gas struts can include various types of struts such as a fixed height cylinder, a spindle, a cable cylinder, a staged cylinder, a non-rotating cylinder, and/or the like and/or combinations thereof. The struts can include various features such as, for example, telescoping mechanisms for extending stroke, adjustable push-in force knobs or wires, degressive response mechanisms, and/or the like. The struts can include one or more tabs disposed along the length of the strut, which can function as mounting points to couple the struts to the isolation element. In some embodiments, a number of struts can be formed from a single component to simplify assembly.

The sorting device 242 can be coupled to the conveyor system 246 to transport and/or distribute the sorted aquatic animals to either the set of tanks 280, the return system 260, or to directly discard aquatic animals to the body of water in which the vessel 200 is being operated. More specifically, the sorting device 242 can include, for example, an outlet or the like that can allow sorted aquatic animals to exit the sorting device 242. In some embodiments, the sorting device 242 can include an outlet manifold (not shown) that can direct the sorted aquatic animals to additional components of the grading/sorting system 240 such as, for example, the conveyer system 246. More particularly, the outlet manifold can include multiple channels, tubes, chutes, tracks, ports, and/or structures, each of which receives a sorted subset of the aquatic animals (e.g., based on size, shape, weight, etc.). In some embodiments, for example, the sorting device 242 can be configured to sort aquatic animals into two sorted subsets (e.g., a Pass and a Fail subset) based on an evaluated characteristic, criterion, and/or metric such as predetermined weight (or weight threshold), a predetermined size (or size threshold), or a specific geometry (e.g., shape). In some embodiments, for example, the sorting device 242 can be configured to sort aquatic animals into six sorted subsets of aquatic animals (e.g., mollusks) based on a desired and/or predetermined characteristic and/or criterion. Once sorted and/or separated, the sorted/separated aquatic animals can exit the sorting device 242 via one outlet of the outlet manifold according to the sorting and/or separating criterion(ia). Thus, the outlet manifold, that can provide a corresponding number of structures configured to provide the separated or sorted aquatic animals to different conveyers of the conveyer system based on the desired and/or predetermined characteristic and/or criteria.

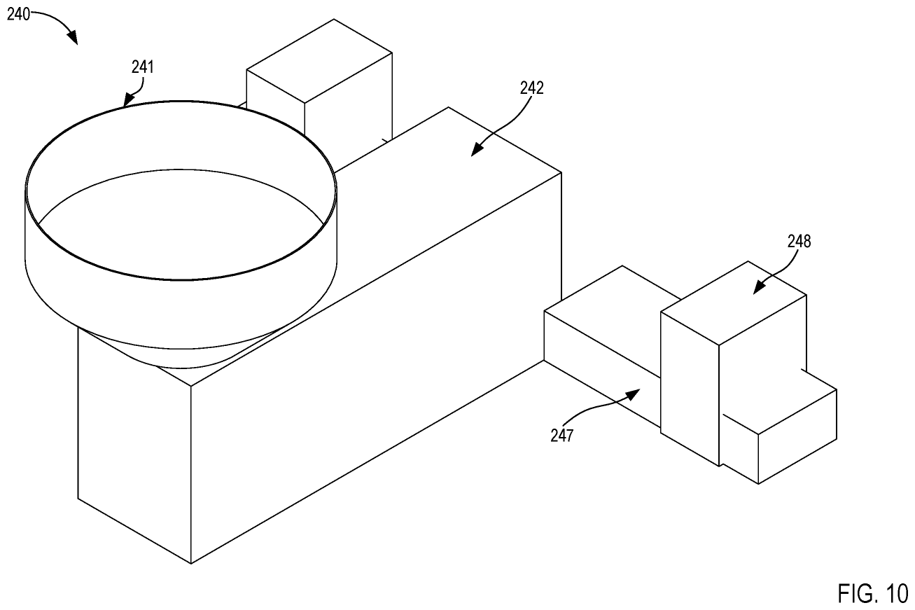

The conveyor system 246 can be any suitable system or combination of systems configured to transport the sorted aquatic animals (e.g., mollusks). In some embodiments, the conveyor system 246 can be coupled to a control system (not shown), configured to control and/or communicate with one or more portions of the conveyor system 246 (e.g., via any suitable control algorithm(s), artificial intelligence algorithm(s), machine learning algorithm(s), and/or the like. In some embodiments, the conveyor system 246 can include one or more conveyors 247 such as, for example, belt conveyors, chain conveyors, pneumatic conveyors, flexible conveyors, line shaft roller conveyor, screw or auger conveyors, and/or the like. More specifically, as shown in FIG. 10-13, the conveyor system 246 can include one or more belt conveyors 247 coupled to the sorting device 242 to transport the sorted aquatic animals away from the sorting device 242. Although not shown, each conveyer 247 can be coupled to and/or aligned with a different outlet or different structure of the outlet manifold of the sorting device 242. In this manner, each conveyer 247 can receive a sorted subset of the aquatic animals based on the predetermined characteristic and/or criteria (e.g., size, shape, weight, etc.). The conveyors 247, in turn, are configured to convey the corresponding sorted subset of aquatic animals to either the set of tanks 280, to the return system 260, or to the body of water, facilitating collection of the aquatic animals, the return of the aquatic animals that do not meet the predetermined characteristic(s) to the aquaculture system 290, and/or the discard or disposal of the aquatic animals that do not meet the predetermined characteristic(s) into the body of water in which the vessel 200 is being operated.

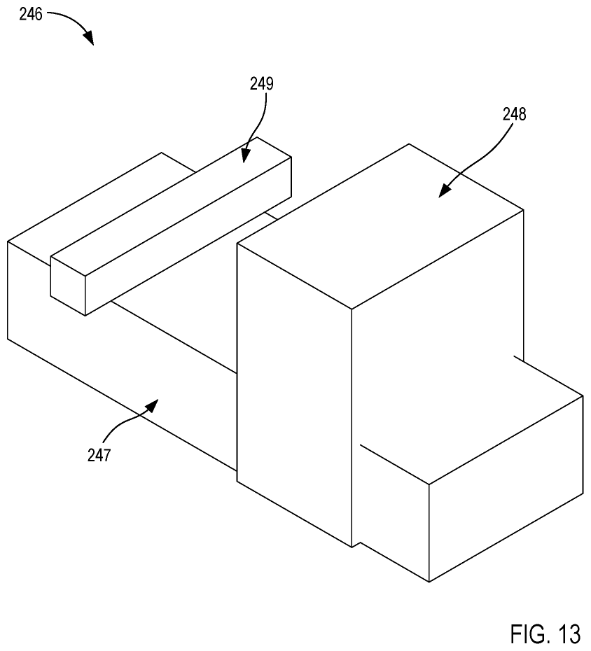

In some embodiments, the conveyors 247 are configured to convey the corresponding sorted subset of aquatic animals to or past one or more counters/scanners 248 configured to count and/or otherwise scan the number of aquatic animals sorted prior to conveying the aquatic animals to the set of tanks 280 and/or the return system 260. The counters/scanners 248 (referred to for simplicity as “scanners 248”) can be any suitable device, system, and/or mechanism configured to count and/or scan the aquatic animals graded, sorted, and/or sampled. A scanner 248 can be coupled to each of the conveyors 247 of the conveyor system 246 (see e.g., FIGS. 12 and 13). In some embodiments, scanners 248 can be, for example, optical counter scanners such as, for example, light blocking counters, light scattering counters, direct imaging counters, and/or the like. In some embodiments, each scanner 248 can be and/or can include, for example, at least one high-speed camera configured to capture or record images and/or other data from one or more viewing angles, and an image acquisition and image analysis unit configured to execute any suitable analysis software to provide high-speed counting with high accuracy. For example, in some implementations, the analysis software (executed by a control system, analysis unit, and/or other compute device) can perform one or more processes, functions, and/or methods associated with identifying and/or recognizing the aquatic animals, assessing whether the aquatic animals satisfy one or more predetermined criterion(ia), counting a number of the aquatic animals that satisfy the one or more predetermined criterion(ia), and/or any other suitable processes.

The conveyor system 246 and/or each conveyor 247 included therein can also include one or more spreaders 249 (e.g., a spreader for each conveyer) configured to place the aquatic animals in a desired configuration (see e.g., FIG. 13). In some embodiments, the spreaders 249 can organize and/or spread the aquatic animals (e.g., consecutively in one or more lines) to facilitate counting with the scanners 248. In some embodiments, the spreaders 249 can be and/or can include any number of flexible, semi-rigid, or rigid tines, fingers, protrusions, etc., that can selectively engage the aquatic animals as they advance along the conveyors 247 prior to entering and/or otherwise passing the scanners 248. In some embodiments, the spreaders 249 can be coupled to and/or can include one or more sensors configured to sense and/or detect one or more characteristics associated with the aquatic animals. For example, in some instances, the tines, fingers, protrusions, etc. (referred to herein for simplicity as “tines”) can be moved, rotated, and/or transitioned in response to contacting an aquatic animal. The movement, rotation, and/or transition of the tines can be sensed and/or detected by the one or more sensors and data associated with an output of the sensor(s) can be analyzed (e.g., by the control system, an analysis unit, and/or other compute device) to determine and/or confirm whether the aquatic animals satisfy and/or meet the predetermined criterion(ia) associated with that subset of aquatic animals. In other words, data output by the one or more sensors can be analyzed to determine whether the aquatic animals transferred to that conveyer 247 are the expected size and/or shape or are within an acceptable range of sizes and/or shapes. In other embodiments, the conveyor system 246 need not include such sensors.

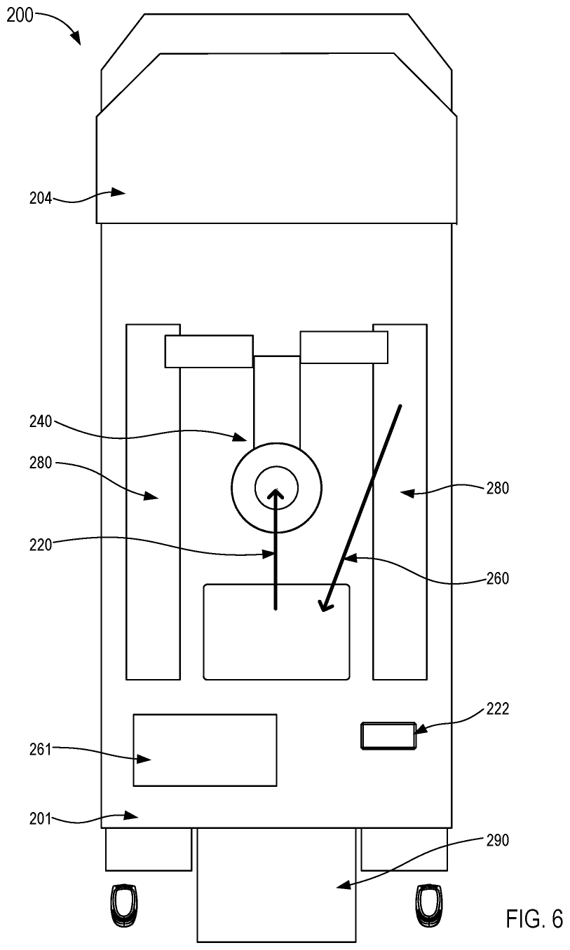

As described above, the conveyors 247 can be configured to convey the sorted, counted, and scanned aquatic animals to a corresponding tank 280 from the set of tanks 280 and/or to the return system 260. In this manner, each tank 280 can be coupled to and/or aligned with a separate conveyor 247 of the conveyor system 246 and configured to receive, contain, and/or store at least some of the aquatic animals sorted by the grading/sorting system 240 (see e.g., FIGS. 6 and/or 9).

In some embodiments, the tanks 280 can be disposed in and/or formed by the hulls 203 of the vessel 200 and/or portion(s) thereof. The set of tanks 280 can be any suitable shape and/or size. For example, a size and/or shape of the tanks 280 can be at least partially based on a size, and/or shape of the hull 203 in which is disposed of by which it is formed. The set of tanks 280 can be dimensioned to contain a desired amount of aquatic animals. For example, in some embodiments, the set of tanks 280 can be sufficiently large and/or can otherwise have or form a collective volume that is sufficient to contain the aquatic animals transferred from the aquaculture system 290 when the aquaculture system 290 is at a maximum capacity. Moreover, the set of tanks 280 can be configured to contain, for example, at least a minimum amount of water and/or liquid solution to facilitate preserving the aquatic animals disposed therein.

Although not shown, the set of tanks 280 can include a water recirculation system with one or more bio-filters, sand filters, and/or ultra-violet filters to purify, clean, and/or sterilize the water and preserve the aquatic animals. The set of tanks 280 can also include a valve, inlet, or port (not shown) configured to allow a flow of liquid into or out of the tanks 280 (e.g., to at least partially fill one or more tanks 280 with water, collect samples of water for quality control purposes, and/or the like). In some embodiments, the tanks 280 can have a tapered and/or funnel-like shape that can facilitate a relatively uniform distribution of aquatic animals therein. In some embodiments, the tanks 280 can include, for example, an outlet or the like that can be transitioned from a closed state to an open state to allow the aquatic animals to be quickly released and/or otherwise transferred from the tanks 280 (e.g., at a harvesting or offloading facility and/or the like). In other embodiments, the tanks 280 need not include such an outlet. In such embodiments, for example, the aquatic animals can be released, removed, harvested, and/or offloaded via the return system 260, as described in further detail herein.

The return system 260 can be any suitable system or combination of systems. For example, the return system 260 can be a system or combination of systems configured to collect or remove from the set of tanks 280 the aquatic animals that do not meet the predetermined characteristics and/or do not satisfy the predetermined criteria, and to return them to the aquaculture system 290. In addition (or as an alternative), the return system 260 can be a system or combination of systems configured to transport and/or transfer sorted, counted, and scanned aquatic animals from the tanks 280 to one or more other storage members, holders, conveyers, etc. of a harvesting, collecting, and/or offloading system or station (e.g., not necessarily included in the vessel 200). For example, the return system 260 can be used to offload the sorted and collected aquatic animals at a harvesting and/or processing facility or the like.

In some embodiments, return system 260 can be similar to or substantially the same as the return system 160 described above with reference to FIG. 1. Thus, portions and/or aspects of the return system 260 may not be described in further detail herein. In some embodiments, the return system 260 can be coupled to and/or at least partially disposed in the set of tanks 280 to transfer at least some of the aquatic animals contained in the tanks 280 to other systems, devices, locations, and/or the like (e.g., the aquaculture system 290 (or a different or separate aquaculture system), a harvesting and/or processing facility, and/or the like). In some embodiments, the return system 260 can be coupled to the conveyor system 246 to directly transport at least a portion of the aquatic animals sorted in or by the sorting device 242 to the aquaculture system 290 (e.g., the aquatic animals that do not satisfy the predetermined criteria such as, for example, aquatic animals that are too small or young to harvest.

In some embodiments, the return system 260 can include at least one compressor 261. as Although not shown, the return system 260 can also include, for example, one or more high-pressure line(s) or pipe(s), one or more pump(s) (e.g., an ejector-jet pump, an aspirator, a venturi pump, and/or the like), one or more flexible hose(s) or hollow collection tube(s), and/or the like. The compressor(s) 261 can be configured such that fluid, gas, and/or air from an external source or from the atmosphere can be pressurized and flowed through the high-pressure line(s) coupled to the compressor 261. In some embodiments, the high-pressure line(s) can be coupled to and/or placed in fluid communication with the one or more pumps, wherein the flow of pressurized fluid results in a negative pressure differential (e.g., vacuum and/or suction force) within the pump. The pumps, in turn, can be coupled to one or more flexible hose or hollow tubing configured to communicate the negative pressure differential (e.g., the vacuum and/or suction force) to draw aquatic animals from the tanks 280 and into the return system 260, which are then returned to the aquaculture system 290 and/or provided to any other suitable container, facility, system, etc. (as described above).

The compressor(s) 261 can be and/or can include one or more of a low-pressure compressor, a medium-pressure compressor, a high-pressure compressor, and/or any suitable combination thereof. The compressor(s) 261 can be, for example, positive displacement compressors, dynamic displacement compressors, single stage reciprocating compressors, two-stage reciprocal compressors, screw-type compressors, rotary vane pumps, scroll compressor, turbo compressors, centrifugal compressors, and/or the like. The compressor(s) 261 can be configured to be cooled by air, water, or an oil working fluid. In some embodiments, the compressor(s) 261 can be configured to provide a flow of compressed or pressurized fluid at any suitable pressure such as, for example, a pressure sufficient to activate a number of pumps (e.g., venturi pumps) and/or otherwise result in a desired amount of vacuum produced by the pumps. For example, the compressor(s) can provide a flow of compressed or pressurized fluid between about 10 pounds per square inch (psi) to about 100 psi or more. In some implementations, the pressure can be about 10 psi, 20 psi, 30 psi, 40 psi, 50 psi, 60 psi, 70 psi, 80 psi, 90 psi, 100 psi, or more or any suitable pressure therebetween. In some implementations, the pressure can be about 80 psi.

In some embodiments, the high-pressure lines of the return system 260 can be made of metals or metal alloys such as cast iron, copper, carbon steel, galvanized steel, stainless steel, aluminum, and/or any suitable material. In some embodiments, the high-pressure lines can be made of polymers and/or plastics such as polyvinylchloride (PVC), polyethylene(s), polypropylene(s), polyurethane(s), nylon(s), and/or the like or copolymers thereof. In some embodiments, the high-pressure lines can include various accessories such as valves, fittings, line filters, check valves, safety heads, rupture discs and the like configured to facilitate the flow of compressed fluid to one or more intended locations. In some embodiments, the return hoses can be any suitable hose or hollow tube that possess a mechanical strength sufficient to not collapse in response to a vacuum or negative pressure created therein. For example, the return hoses can be made of various materials such as thermoplastic elastomers (TPEs), poly vinyl chloride (PVC), rubber, norprene, neoprene, polyethylene, polypropylene, silicon, nylon, and/or the like or copolymers thereof. In some embodiments, the return hoses can be relatively flexible allowing the return hoses to be bent, flexed, and/or otherwise reconfigured.

As described above, the pumps can be, for example, venturi pumps and/or the like. In some embodiments, one of the high-pressure lines (or a portion of the high-pressure lines) is coupled to a high-pressure inlet of one of the venturi pumps, a first or inlet return hose is coupled to a low-pressure inlet of the venturi pump, and a second or outlet return hose is coupled to a low-pressure outlet of the venturi pump. Moreover, in this embodiment, the return system 260 includes similarly arranged venturi pumps for or associated with each tank 280 from the set of tanks 280. In some implementations, the high-pressure inlet of the venturi pumps can receive a flow of compressed or pressurized fluid, which results in a negative pressure within a portion of the venturi pump that is operable to draw a vacuum through the venturi pump between the low-pressure inlet and the low-pressure outlet. In this manner, the pressure differential generated by the venturi pumps can be used to transfer at least some of the aquatic animals from the tanks 280 and into the return system 260 via the return hoses coupled to the venturi pumps.

Although not shown, in some implementations, at least some of the return hoses coupled to the low-pressure outlet of the venturi pumps can be further coupled to or in fluid communication with a transfer device (and/or system) allowing the aquatic animals flow in the return hoses to be transferred out of the return system 260. For example, the transfer device can include a transfer hose that includes and/or forms an inlet, inlet hopper, and/or the like that can receive a flow of water and/or aquatic animals from a return hoses associated with each of the tanks 280. The transfer hose can be flexible, movable, and/or otherwise reconfigurable allowing the transfer hose to be placed in any desired position (e.g., via human or manual intervention, and/or via an electronically controlled device, machine, etc.).

In some instances, the return system 260 can be configured to draw at least a portion of the aquatic animals disposed in the tanks 280 into the return system 260 and to convey the portion of the aquatic animals to, for example, the aquaculture system 290 via a transfer hose (not shown). In such instances, the portion of the aquatic animals can be, for example, aquatic animals (e.g., mollusks) that are too small, too young, and/or otherwise do not satisfy or meet the predetermined criterion(ia) and the transfer hose can be manipulated such that an end portion thereof is disposed in and/or otherwise placed in fluid communication with at least one pen of the aquaculture system 290. In some instances, the return system 260 can be configured to draw at least a portion of the aquatic animals disposed in the tanks 280 into the return system 260 and to convey the portion of the aquatic animals to, for example, a harvesting and/or processing facility, one or more subsequent storage containers, device, and/or systems, one or more other or different aquaculture systems, and/or the like. In such instances, the portion of the aquatic animals can be, for example, aquatic animals that satisfy and/or meet the predetermined criterion(ia) such as, for example, being sufficiently large or old for harvesting.

In some instances, the return system 260 can be configured to return the aquatic animals to the aquaculture system 290 and/or provide the aquatic animals for harvesting based at least in part on the sorting criteria associated with each tank 280. For example, in some instances, aquatic animals not ready for harvesting (e.g., are too small, too young, and/or do not meet or satisfy the predetermined criteria) can be sorted by the sorting device 242 and provided to at least one predetermined tank 280 (e.g., tank “A”) while aquatic animals that are ready for harvesting (e.g., that do meet or satisfy the predetermined criteria) can be sorted by the sorting device 242 and provided to at least one predetermined tank 280 (e.g., tank “B”). In such instances, the return system 260 can be configured (e.g., automatically and/or in response to human intervention) to transfer the aquatic animals from tank A to the aquaculture system 290, and configured (e.g., automatically and/or in response to human intervention) to transfer the aquatic animals from tank B to a harvesting and/or processing facility, one or more subsequent storage containers, device, and/or systems, one or more other or different aquaculture systems, and/or the like. Thus, the return system 260 can selectively transfer the aquatic animals from the tanks 280 based at least in part on the sorting performed by the grading/sorting system 260.

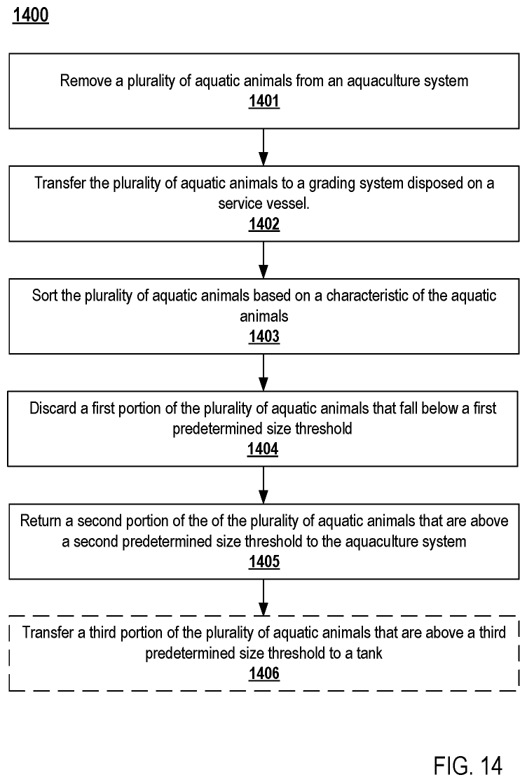

FIG. 14 shows a flowchart illustrating a method 1400 of using a vessel such as those described herein for grading and harvesting aquatic animals cultivated in an aquaculture system. In some embodiments, the vessel can be similar to and/or substantially the same as the vessel 100 and/or 200 used with the aquaculture system 190, 290 and/or other aquaculture systems configured to cultivate any suitable aquatic species, animal, and/or plant, as described herein.

The method 1400 includes removing a plurality of aquatic animals from an aquaculture system, at 1401. The aquatic animals can include, for example, animals from the phylum Mollusca (e.g., oysters, clams, mussels, scallops, bivalves, abalone, and/or the like) stored and or contained in the aquaculture system. In some embodiments, the aquatic animals can be removed or drawn from the aquaculture system by applying a vacuum or a negative pressure in the enclosures or pens of the aquaculture system to facilitate flow of aquatic animals and water. In some instances, the removal of the aquatic animals from the aquaculture system can be manually controlled (e.g., with the aid of a human operator), while in other instances, the removal of the aquatic animals from the aquaculture system can be controlled automatically (e.g., with the aid of a programmable, semi-autonomous, and/or fully autonomous device).

The method includes at step 1402 transferring the plurality of aquatic animals to a grading system disposed on a service vessel. At step 1403, the method includes sorting the plurality of aquatic animals based on a characteristic of the aquatic animals. For example, in some instances the aquatic animals are sorted according to a binary grading system (e.g., a Pass/Fail system) in which the aquatic animals are evaluated based on a characteristic, criterion, and/or metric such as, for example, a predetermined weight (or weight threshold), a predetermined size (or size threshold), or a specific geometry (e.g., shape) of the aquatic animals. In other instances, the aquatic animals are sorted based on multiple specified or predetermined characteristic(s), criterion(ia), and/or metrics. For example, the aquatic animals can be sorted into two, three, four, five, six, seven, eight, nine, ten or more sorted subsets of aquatic animals (e.g., mollusks) based on a desired and/or predetermined set of weights, sizes, and/or shapes. In some embodiments, sorting the plurality of aquatic animals includes reducing an amount of water transferred to the grading system with the plurality of aquatic animals via one or more ports. In some embodiments, the plurality of aquatic animals sorted based on one or more specified or predetermined characteristic(s), criterion(ia), and/or metrics are counted and/or scanned via counters and/or scanners.

At step 1404, the method includes discarding a first portion of the plurality of aquatic animals that fall below a first predetermined size threshold. The first portion of the plurality of aquatic animals that fall below the first predetermined size threshold can be discarded into the body of water in which the vessel is being operated. In some instances, the aquatic animals discarded are associated with dead aquatic animals or aquatic animals that are growing at a slow pace. In some embodiments, the first portion of the plurality of aquatic animals can be directed to one or more counters/scanners and be counted prior to being discarded.

At step 1405, the method includes returning a second portion of the plurality of aquatic animals that are above a second predetermined size threshold to the aquaculture system. In some instances, the aquatic animals that are above the second predetermined size threshold are associated to aquatic animals growing at a suitable and/or desired pace. Consequently, said aquatic animals are returned to the aquaculture system for further growth. In some embodiments, the second portion of the plurality of aquatic animals can be directed to one or more counters/scanners and be counted prior to being returned to the aquaculture system.

At step 1406 the method optionally includes transferring a third portion of the plurality of aquatic animals that are above a third predetermined size threshold to a tank. In some instances, the aquatic animals that are above the third predetermined size threshold are associated to aquatic animals that have achieved a level of maturity or growth suitable for harvesting. Consequently, said aquatic animals are transferred to a tank such as the tanks described with respect to the vessel 100 and 200 herein. In some embodiments, the third portion of the plurality of aquatic animals can be directed to one or more counters/scanners and be counted prior to being transferred to a tank.

While the grading/sorting system 240 is described above as sorting the aquatic animals based on one or more predetermined characteristics and/or in response to satisfying or meeting a predetermined criterion(ia) such as predetermined size (or size threshold), a predetermined weight (or weight threshold), a specific shape, etc., in some implementations, the grading/sorting system 240 can sort the aquatic animals using any other characteristic as a sorting criterion(ia). For example, the grading/sorting system 240 can separate, sort, and/or reject any dead aquatic animals, sick or unhealthy aquatic animals, aquatic animals that are developing too slowly, and/or the like. In some implementations, the grading/sorting system 240 can perform at least a portion of a sorting process based on density and/or appearance allowing the undesired aquatic animals to be separated from the otherwise desirable aquatic animals. In some implementations, the sorting device 242 can include a sorting layer, screen, and/or mechanism configured to separate and remove such undesirable aquatic animals. In some implementations, the sorting device 242 can include an outlet that can release the rejected aquatic animals into the body of water (e.g., ocean). In some implementations, the sorting device 242 can include an outlet that can deliver the rejected aquatic animals to a dedicated and/or separate tank 280. In such implementations, the tank 280 can include an outlet or the like allowing the rejected aquatic animals to be returned to the ocean. Alternatively, the return system 260 can be configured to remove the rejected aquatic animals from the tank 280 (as described above) and to return them to the ocean and/or to an offloading location separate from the other harvested aquatic animals.

The embodiments described herein (e.g., the vessel 100 and/or 200) can include any suitable control system that can be used to and/or otherwise configured to monitor and control a vessel locally and/or remotely. In some embodiments, the control system can be configured to monitor and/or control the vessel via a control algorithm, an artificial intelligence algorithm, a machine learning algorithm or system, a human operator, and/or any suitable combination thereof. For example, in some instances, a user, operator, and/or administrator of the vessel can provide an operational command to the control system via a user interface and/or from a remote location by sending a signal via a remote electronic device, a remote controller, a personal computer, a workstation, a mobile device, a tablet, a wearable electronic device, and/or any other suitable compute device. The signal can be indicative of the operational command to the control system and/or any other portion of the vessel. In other instances, the control system can be configured to monitor and/or control the vessel without user or operator input or manipulation.

In some embodiments, the control system can include at least a portion of a power system and/or any other suitable portion of the vessel. In some embodiments, the control system and/or a portion of the control system can be mounted at any suitable position on or in the vessel (e.g., in a wheelhouse). In other embodiments, the control system and/or a portion of the control system can be a remote system that is not physically located on or in the vessel.

The control system can include, for example, a controller, a compute device, an electronic device, and/or any other suitable electronic or electromechanical control system. For example, in some embodiments, the control system can include an electronic compute device configured to execute and/or perform one or more processes associated with controlling the vessel. In some embodiments, the electronic compute device can be, for example, a computer or compute device or system such as a single board computer, a stackable computer system, a personal computer (PC), a server device, a workstation, programmable logic device (PLD), and/or the like.

In some embodiments, such an electronic computer device or controller can include at least a memory, a processor, and a network interface. For example, in some embodiments, the memory can be, for example, a random access memory (RAM), a memory buffer, a hard drive, a read-only memory (ROM), an erasable programmable read-only memory (EPROM), a flash memory, and/or the like. The processor can be any suitable processing device configured to run or execute a set of instructions or code. For example, the processor can be a general purpose processor, a central processing unit (CPU), an accelerated processing unit (APU), a graphics processor unit (GPU), an Application Specific Integrated Circuit (ASIC), a field programmable gate array (FPGA), and/or the like. The network interface can be, for example, a network interface card and/or the like that can include at least an Ethernet port, a wireless radio (e.g., a WiFi® radio, a Bluetooth® radio, etc.), a high frequency radio, a satellite communication interface, and/or the like. As such, the processor can be configured to run or execute a set of instructions or code stored in the memory associated with controlling one or more portions of the vessel and/or communicating with one or more portions of the vessel and/or any suitable remote electronic device, via the network interface. In addition, in some embodiments, the control system can include a user interface such as a display, one or more peripheral devices, and/or any other suitable user interface, thereby allowing a human operator to interact with the control system.

In some implementations, the control system can include at least a high-bandwidth wireless networking system having any suitable components (e.g., a wireless networking card and antenna, an acoustic modem card and transducer, a cellular network modem and antenna allowing communication with a 2G, 3G, 4G/LTE, 5G, and/or other cellular network, and/or any other suitable components), other peripheral instrumentation, a portion of a power system (e.g., one or more engines, generators, motors, batteries, renewable power systems such as solar or wind, etc.), and/or the like. In some embodiments, the vessel (e.g., the control system) can include and/or can implement a global positioning system (GPS) device to enable an operator, a system administrator, a control algorithm, an artificial intelligence procedure or algorithm, and/or the like to track the location of the vessel substantially in real-time. In some embodiments, the control system can receive data from the GPS device and can determine a position of the vessel and/or can otherwise relay the data to the operator or control algorithm. In some instances, the operator or control algorithm can control one or more operations of the vessel based at least in part on the GPS data.

In some embodiments, the control system can provide and/or can perform status checks on various systems including, but not limited to a vacuum system, a grading/sorting system, a conveyor system, a return system, and/or any other suitable system. In some instances, a human operator can provide an input or command to the control system indicative of an instruction to control one or more portions and/or systems of the vessel.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, an FPGA, an ASIC, and/or the like. Software modules (executed on hardware) can be expressed in a variety of software languages (e.g., computer code), including C, C++, Java™, Ruby, Visual Basic™, Python™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools, and/or combinations thereof (e.g., Python™). Additional examples of computer code include, but are not limited to, control signals, encrypted code, and compressed code. In some instances, software, hardware, or a combination thereof can be used in any suitable controller, control system, and/or the like implementing any suitable control scheme such as, for example, a proportional-integral-derivative (PID) controller, and/or the like.

While various embodiments have been particularly shown and described, it should be understood that they have been presented by way of example only, and not limitation. Various changes in form and/or detail may be made without departing from the spirit of the disclosure and/or without altering the function and/or advantages thereof unless expressly stated otherwise. Where schematics and/or embodiments described above indicate certain components arranged in certain orientations or positions, the arrangement of components may be modified.

Although various embodiments have been described as having particular features and/or combinations of components, other embodiments are possible having a combination of any features and/or components from any of embodiments described herein, except mutually exclusive combinations. The embodiments described herein can include various combinations and/or sub-combinations of the functions, components, and/or features of the different embodiments described.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

1. An apparatus, comprising:
a vessel configured to facilitate access to aquatic animals contained in an aquaculture system;
a grading system disposed on the vessel and configured to receive a plurality of aquatic animals and sort the plurality of aquatic animals based on a characteristic; and
a return system disposed on the vessel and configured to transfer at least a portion of the plurality of aquatic animals back to the aquaculture system.

2. The apparatus of claim 1, wherein the grading system is configured to transfer a portion of the plurality of aquatic animals to the return system that do not satisfy the characteristic.

3. The apparatus of claim 1, wherein the grading system is configured to discard a portion of the plurality of aquatic animals that do not satisfy the characteristic.

4. The apparatus of claim 1, wherein the characteristic is greater than a predetermined size.

5. The apparatus of claim 1, wherein the characteristic is less than a predetermined size.

6. The apparatus of claim 1, further comprising:
a tank disposed on the vessel configured to store at least a portion of the plurality of aquatic animals.

7. The apparatus of claim 1, further comprising:
a vacuum system for transferring aquatic animals between the aquaculture system and the vessel.

8. The apparatus of claim 1, wherein the vessel includes a pair of hulls to allow the vessel to float over the aquaculture system.

9. The apparatus of claim 1, wherein the grading system includes an isolator element configured to dampen the vibrations generated by the grading system during its operation.

10. The apparatus of claim 1, wherein the grading system includes a conveyor configured to convey the at least a portion of the plurality of aquatic animals to a counter for counting the number of aquatic animals.

11. A service vessel for grading or harvesting aquatic animals from an aquaculture system, the service vessel comprising:
a pair of hulls to allow the vessel to float over the aquaculture system;
a transfer system configured to remove a plurality of aquatic animals from the aquaculture system;
a grading system configured to receive the plurality of aquatic animals from the transfer system and sort the plurality of aquatic animals based on a characteristic; and
a return system disposed on the vessel and configured to transfer at least a portion of the plurality of aquatic animals back to the aquaculture system.

12. The service vessel of claim 11, wherein the grading system is configured to discard any aquatic animals from the plurality of aquatic animals that fall below a predetermined size threshold.

13. The service vessel of claim 11, wherein the grading system is configured to transfer to a tank any aquatic animals from the plurality of aquatic animals that fall above a predetermined size threshold.

14. The service vessel of claim 11, wherein the transfer system includes a vacuum pump disposed on the vessel and configured to route a negative pressure generated by the vacuum pump to the aquaculture system.

15. The service vessel of claim 11, wherein the grading system includes an isolator element configured to dampen the vibrations generated by the grading system during its operation.

16. The service vessel of claim 11, wherein the grading system includes a conveyor configured to convey the at least a portion of the plurality of aquatic animals to a counter for counting the number of aquatic animals.

17. A method, comprising:
removing a plurality of aquatic animals from an aquaculture system;
transferring the plurality of aquatic animals to a grading system disposed on a service vessel;
sorting the plurality of aquatic animals based on a characteristic of the aquatic animals;
discarding a first portion of the plurality of aquatic animals that fall below a first predetermined size threshold; and
returning a second portion of the plurality of aquatic animals that are above a second predetermined size threshold to the aquaculture system.

18. The method of claim 17, further comprising:
transferring a third portion of the plurality of aquatic animals that are above a third predetermined size threshold to a tank.

19. The method of claim 18, wherein the third predetermined size threshold is greater than the second predetermined size threshold.

20. The method of claim 17, wherein the characteristic of the aquatic animals includes a predetermined weight.

21. The method of claim 17, wherein the characteristic of the aquatic animals includes multiple predetermined sizes.

22. The method of claim 17, wherein sorting the plurality of aquatic animals includes reducing an amount of water transferred to the grading system with the plurality of aquatic animals.

23. The method of claim 17, further comprising:
counting the first portion of the plurality of aquatic animals that fall below the first predetermined size threshold.

24. The method of claim 17, further comprising:
counting second portion of the plurality of aquatic animals that are above the second predetermined size threshold.

25. The method of claim 18, further comprising:
counting the third portion of the plurality of aquatic animals that are above the third predetermined size threshold.
